(19) United States
(12) Patent Application Publication
(10) Pub. No.: US 2026/0142831 A1
(43) Pub. Date: May 21, 2026

(54) SYSTEM INFORMATION BLOCK ENCRYPTION IN WIRELESS COMMUNICATIONS

(71) Applicant: QUALCOMM Incorporated, San Diego, CA (US)

(72) Inventor: Andrew PERNG, San Diego, CA (US)

(21) Appl. No.: 19/393,318

(22) Filed: Nov. 18, 2025

Related U.S. Application Data
(60) Provisional application No. 63/723,574, filed on Nov. 21, 2024.

(51) Int. Cl. H04L 9/32; H04L 9/06; H04W 12/03

(52) U.S. Cl. CPC H04L 9/3242; H04L 9/0631; H04W 12/03

(57) ABSTRACT

Methods, systems, and devices for wireless communications are described in which a network entity may transmit a system information block (SIB) that includes a message authentication code (MAC) for verification at a user equipment (UE) prior to processing of the SIB. Any authorized UEs that receive the SIB may each compute a MAC for the transmitted SIB, and verify the authenticity of the SIB transmission based on whether the computed MAC matches a MAC that is transmitted with the SIB. If the MACs match, the SIB transmission may be provided for further processing, and otherwise the SIB transmission may be discarded.

### CROSS REFERENCES

The present Application for Patent claims benefit of U.S. Provisional Patent Application No. 63/723,574 by PERNG et al., entitled “SYSTEM INFORMATION BLOCK ENCRYPTION IN WIRELESS COMMUNICATIONS,” filed Nov. 21, 2024, assigned to the assignee hereof, and expressly incorporated herein.

### FIELD OF TECHNOLOGY

The following relates to wireless communications, including system information block encryption in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first system information block (SIB) at a physical layer of the UE, the first SIB including a set of bits, partitioning the set of bits of the first SIB into a first subset of bits that correspond to a first message authentication code of the first SIB and a second subset of bits that correspond to SIB bits of the first SIB, computing a second message authentication code for the second subset of bits in accordance with a hash algorithm associated with the first SIB, and determining whether to process the first SIB or discard the first SIB based on whether the second message authentication code matches the first message authentication code.

A UE for wireless communications is described. The UE may include one or more memories storing processor executable code, and one or more processors coupled with the one or more memories. The one or more processors may individually or collectively be operable to execute the code to cause the UE to receive a first SIB at a physical layer of the UE, the first SIB including a set of bits, partition the set of bits of the first SIB into a first subset of bits that correspond to a first message authentication code of the first SIB and a second subset of bits that correspond to SIB bits of the first SIB, compute a second message authentication code for the second subset of bits in accordance with a hash algorithm associated with the first SIB, and determine whether to process the first SIB or discard the first SIB based on whether the second message authentication code matches the first message authentication code.

Another UE for wireless communications is described. The UE may include means for receiving a first SIB at a physical layer of the UE, the first SIB including a set of bits, means for partitioning the set of bits of the first SIB into a first subset of bits that correspond to a first message authentication code of the first SIB and a second subset of bits that correspond to SIB bits of the first SIB, means for computing a second message authentication code for the second subset of bits in accordance with a hash algorithm associated with the first SIB, and means for determining whether to process the first SIB or discard the first SIB based on whether the second message authentication code matches the first message authentication code.

A non-transitory computer-readable medium storing code for wireless communications is described. The code may include instructions executable by one or more processors to receive a first SIB at a physical layer of the UE, the first SIB including a set of bits, partition the set of bits of the first SIB into a first subset of bits that correspond to a first message authentication code of the first SIB and a second subset of bits that correspond to SIB bits of the first SIB, compute a second message authentication code for the second subset of bits in accordance with a hash algorithm associated with the first SIB, and determine whether to process the first SIB or discard the first SIB based on whether the second message authentication code matches the first message authentication code.

Some examples of the method, UEs, and non-transitory computer-readable medium described herein may further include operations, features, means, or instructions for decoding, based on the second message authentication code being different than the first message authentication code, at least a portion of the first SIB to obtain a decoded portion of the first SIB that indicates whether the first SIB is a SIB1 or a different SIB and discarding the first SIB when the first SIB is the SIB1, or providing the first SIB for further processing when the first SIB is the different SIB.

In some examples of the method, UEs, and non-transitory computer-readable medium described herein, the decoding may include operations, features, means, or instructions for decoding at least the portion of the first SIB in accordance with an Abstract Syntax Notation One (ASN.1) decoding procedure.

Some examples of the method, UEs, and non-transitory computer-readable medium described herein may further include operations, features, means, or instructions for partitioning, based on the second message authentication code matching the first message authentication code, the SIB bits of the first SIB into SIB payload bits and an initialization vector and decrypting the SIB payload bits in accordance with an Advanced Encryption Standard (AES) procedure using the initialization vector.

Some examples of the method, UEs, and non-transitory computer-readable medium described herein may further include operations, features, means, or instructions for discarding the first SIB when the AES procedure indicates a failed decryption and decoding at least a portion of the SIB payload in accordance with an ASN.1 decoding procedure to confirm the first SIB is a SIB1 and providing the first SIB for further processing.

In some examples of the method, UEs, and non-transitory computer-readable medium described herein, the initialization vector is a 12 byte AES initialization vector that is appended to the SIB payload bits.

In some examples of the method, UEs, and non-transitory computer-readable medium described herein, the first message authentication code is a 48 byte code appended to the SIB bits of the first SIB, where the SIB bits include a SIB payload and an initialization vector, and where the second message authentication code is a corresponding 48 byte code computed on the SIB payload and the initialization vector using a hash-based message authentication code (HMAC)-Secure Hash Algorithm (SHA)-384 procedure and an HMAC-SHA-384 private key at the UE.

In some examples of the method, UEs, and non-transitory computer-readable medium described herein, the HMAC-SHA-384 private key at the UE is a 48 byte private key that is stored at the UE.

A method for wireless communications by a network entity is described. The method may include encrypting an SIB payload in accordance with an encryption algorithm and generating an associated initialization vector for decryption of the SIB payload, computing a first message authentication code in accordance with a hash algorithm performed on the SIB payload and the associated initialization vector, and transmitting a first SIB message that includes the SIB payload, the associated initialization vector, and the first message authentication code.

A network entity for wireless communications is described. The network entity may include one or more memories storing processor executable code, and one or more processors coupled with the one or more memories. The one or more processors may individually or collectively be operable to execute the code to cause the network entity to encrypt an SIB payload in accordance with an encryption algorithm and generating an associated initialization vector for decryption of the SIB payload, compute a first message authentication code in accordance with a hash algorithm performed on the SIB payload and the associated initialization vector, and transmit a first SIB message that includes the SIB payload, the associated initialization vector, and the first message authentication code.

Another network entity for wireless communications is described. The network entity may include means for encrypting an SIB payload in accordance with an encryption algorithm and generating an associated initialization vector for decryption of the SIB payload, means for computing a first message authentication code in accordance with a hash algorithm performed on the SIB payload and the associated initialization vector, and means for transmitting a first SIB message that includes the SIB payload, the associated initialization vector, and the first message authentication code.

A non-transitory computer-readable medium storing code for wireless communications is described. The code may include instructions executable by one or more processors to encrypt an SIB payload in accordance with an encryption algorithm and generating an associated initialization vector for decryption of the SIB payload, compute a first message authentication code in accordance with a hash algorithm performed on the SIB payload and the associated initialization vector, and transmit a first SIB message that includes the SIB payload, the associated initialization vector, and the first message authentication code.

In some examples of the method, network entities, and non-transitory computer-readable medium described herein, the SIB payload is a SIB1 payload.

Some examples of the method, network entities, and non-transitory computer-readable medium described herein may further include operations, features, means, or instructions for encoding the SIB payload in accordance with an ASN.1 encoding procedure.

In some examples of the method, network entities, and non-transitory computer-readable medium described herein, the encryption algorithm is an AES algorithm that encrypts the SIB payload by using the initialization vector.

In some examples of the method, network entities, and non-transitory computer-readable medium described herein, the initialization vector is a 12 byte AES initialization vector that is appended to the SIB payload.

In some examples of the method, network entities, and non-transitory computer-readable medium described herein, the first message authentication code is a 48 byte code appended to the SIB payload and the initialization vector, and where the 48 byte code is computed on the SIB payload and the initialization vector using a HMAC-SHA-384 hashing algorithm and an HMAC-SHA-384 private key at the network entity.

In some examples of the method, network entities, and non-transitory computer-readable medium described herein, the HMAC-SHA-384 private key at the network entity is a 48 byte private key that corresponds to an associated HMAC-SHA-384 private key of at least a first UE that is authorized for communication with the network entity.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports system information block encryption in wireless communications in accordance with one or more aspects of the present disclosure.

FIG. 2 shows an example of a portion of a wireless communications system that supports system information block encryption in wireless communications in accordance with one or more aspects of the present disclosure.

FIG. 3 shows an example of a state diagram that supports system information block encryption in wireless communications in accordance with one or more aspects of the present disclosure.

FIG. 4 shows an example of a transmitter and receiver that supports system information block encryption in wireless communications in accordance with one or more aspects of the present disclosure.

FIG. 5 shows an example of a system information block message that supports system information block encryption in wireless communications in accordance with one or more aspects of the present disclosure.

FIGS. 6 and 7 show block diagrams of devices that support system information block encryption in wireless communications in accordance with one or more aspects of the present disclosure.

FIG. 8 shows a block diagram of a communications manager that supports system information block encryption in wireless communications in accordance with one or more aspects of the present disclosure.

FIG. 9 shows a diagram of a system including a device that supports system information block encryption in wireless communications in accordance with one or more aspects of the present disclosure.

FIGS. 10 and 11 show block diagrams of devices that support system information block encryption in wireless communications in accordance with one or more aspects of the present disclosure.

FIG. 12 shows a block diagram of a communications manager that supports system information block encryption in wireless communications in accordance with one or more aspects of the present disclosure.

FIG. 13 shows a diagram of a system including a device that supports system information block encryption in wireless communications in accordance with one or more aspects of the present disclosure.

FIGS. 14 and 15 show flowcharts illustrating methods that support system information block encryption in wireless communications in accordance with one or more aspects of the present disclosure.

### DETAILED DESCRIPTION

Some wireless communications devices may initiate a connection to a wireless network based on one or more system information blocks (SIBs) that are transmitted by a network entity such as a wireless base station or radio node. As used herein, SIBs may refer to messages that are periodically transmitted by a network entity (such as a base station or gNB) that provide system information, scheduling information for other SIBs, and basic cell access information that user equipments (UEs) use to acquire and connect to a cell. SIB1 may be a type of SIB that contains fundamental acquisition parameters that enable a UE to establish initial communication with a wireless network. A potential security vulnerability in some wireless communications systems may be related to SIB transmissions in which a rogue base station (RBS) may transmit SIBs to initiate a UE to initiate a connection with the RBS instead of a desired base station. For example, a RBS may include a node such as a fake base station which may include including an in-coverage fake base station, a man-in-the-middle fake base station, a signal overshadowing fake base station, or the like. The RBS may transmit SIBs at a relatively high power compared with the desired base station, which may trigger a selection or reselection by a UE to attempt a connection with the RBS, which may cause communications disruptions at the UE. In other examples, security vulnerabilities may be associated with undesired commercial base stations which may support a connection with a UE, but may track certain data or traffic patterns that may be used in an undesired manner. Thus, techniques to avoid a UE attempting to connect with such an undesirable radio node may be beneficial.

In accordance with various aspects discussed herein, techniques for SIB transmissions (such as SIB1 transmissions) provide for computing a message authentication code (MAC) for a SIB1 transmission, that is used to verify the authenticity of the SIB1 transmission. As used herein, a MAC may refer to a cryptographic code computed using a hash algorithm (such as hash-based MAC (HMAC)-secure hash algorithm (SHA)-384) and an HMAC-SHA-384 private key to verify authenticity and integrity of transmitted data. A receiving device may compare a received MAC to a MAC computed at the receiving device to confirm that a message has not been tampered with during transmission and that the message originates from an authorized source. An authorized transmitting device, such as a network entity or a base station, may compute a MAC for an encrypted SIB1, and append the MAC to the SIB1 transmission. In some examples, the SIB1 transmission includes an encrypted SIB payload, an unencrypted initialization vector (IV) used for decryption of the encrypted payload, and a MAC that is computed over the encrypted SIB payload and unencrypted IV. A receiving device, such as an authorized UE, may receive the SIB1 transmission, strip the received MAC (such as based on a predefined quantity of bits and a predefined location of the bits in the SIB1 transmission), compute a received MAC based on the remaining bits, compare the computed MAC with the received MAC, and determine whether the SIB1 is authentic based on whether the MACs match. If the MACs match, the SIB1 transmission may be provided for further processing, and otherwise the SIB1 transmission may be discarded. As used herein, a message being “discarded” may refer to a receiving device rejecting the message, a modem of the receiving device refraining from further processing of the message, and/or memory buffers of the receiving device releasing the message. For example, when a SIB is discarded, a receiving device may refrain from using information contained in the SIB for cell acquisition, may refrain from attempting to establish a connection with a device (such as a network entity) that transmitted the SIB, and may invoke cell barring processing to prevent future connection attempts to a cell associated with the SIB.

Such techniques may help prevent a RBS or commercial network from attracting a UE away from an authorized private network (PN) for exploitation. Aspects as discussed herein may provide spoofing mitigation, for example, by preventing rogue UEs from decoding PN SIB1 details, which therefore cannot be used in a passive survey mode to provide the PN system's acquisition information to a RBS to attempt a man-in-the-middle attack. Further, the UE modem of the authorized UE may intercept every incoming SIB1 message, regardless if it is from the legitimate PN system, commercial network or RBS, coming off the physical layer before any other modem processing occurs, and compute a MAC to compare against the received cryptographic MAC. If the MAC is missing or fails the MAC comparison, the modem will discard the received SIB1 message and call cell barring processing to prevent attempts to connect to such a cell. Using such techniques, further processing at the modem of a SIB1 from a RBS or unauthorized commercial network may be avoided and the UE is thus not able to attach to an associated cell. If the MAC check passes, the modem will then decrypt SIB1, decode ASN.1 encoding to verify it is SIB1 and allow it to move forward with system acquisition processing. In accordance with such techniques, the modem will not acquire any base stations except the PN network entity (e.g., PN base station or gNB), as MAC validation and successful AES decryption is performed and used as a whitelist before allowing SIB1 to be processed. The modem code that intercepts these messages directly off the physical layer as they arrive may be instrumented as an initial entry point to the modem for processing, hence can be thought of as a secure gateway entry point to the rest of the modem.

Aspects of the disclosure are initially described in the context of wireless communications systems. Aspects of the disclosure are further illustrated by and described with reference to a state diagram, SIB message diagram, apparatus diagrams, system diagrams, and flowcharts that relate to SIB encryption in wireless communications.

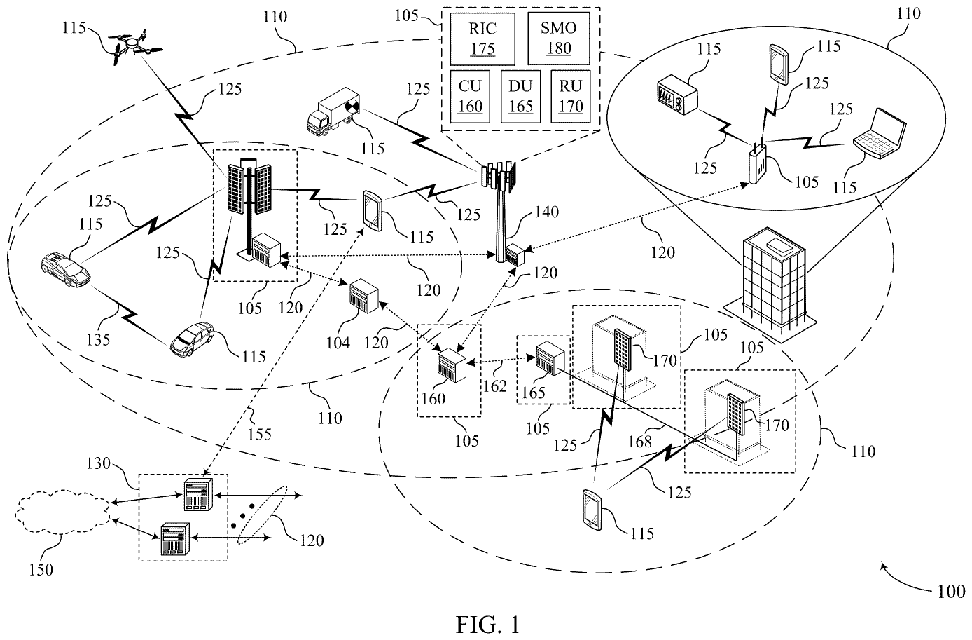

FIG. 1 shows an example of a wireless communications system 100 that supports SIB encryption in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support SIB encryption in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some aspects, one or more network entities 105 may transmit SIB transmissions (such as SIB1 transmissions) that enable a UE 115 to establish a connection with the network entity 105. In some aspects, a network entity 105 and a UE 115 may each compute a MAC for a SIB1 transmission, that is used to verify the authenticity of the SIB1 transmission. In some implementations, an authorized transmitting device, such as a network entity 105, may compute a MAC for an encrypted SIB1, and append the MAC to the SIB1 to generate a SIB1 message. In some examples, the SIB1 transmission may include an encrypted SIB payload, and an unencrypted initialization vector (IV) used for decryption of the encrypted payload. The transmitting network entity 105 may compute a MAC over the encrypted SIB payload and unencrypted IV, and append the MAC to the SIB1. A receiving device, such as an authorized UE 115, may receive the SIB1 message, strip the received MAC (such as based on a predefined quantity of bits and a predefined location of the bits in the SIB1 message), compute a received MAC based on the remaining bits (that is, the SIB payload and IV), and compare the computed MAC with the received MAC. The UE 115 may determine whether the SIB1 is authentic based on whether the MACs match. If the MACs match, the SIB1 may be provided for further processing, and otherwise the SIB1 transmission may be discarded.

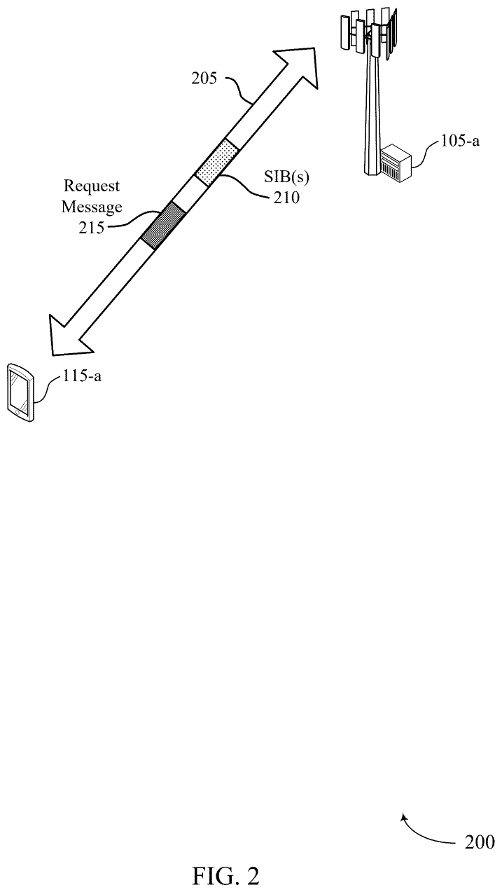

FIG. 2 shows an example of a wireless communications system 200 that supports SIB encryption in wireless communications in accordance with one or more aspects of the present disclosure. The wireless communications system 200 may implement or be implemented by various aspects of the wireless communications system 100. For example, the wireless communications system 200 may include a network entity 105-a and a UE 115-a, which may represent examples of corresponding devices as described with reference to FIG. 1.

In some aspects, the network entity 105-a may transmit one or more SIBs 210 via a communications link 205. The UE 115-a may receive the one or more SIBs 210, and transmit a request message 215, such as a random access channel (RACH) request to initiate a connection with the network entity 105-a. Connection establishment procedures and subsequent communications may then occur between the UE 115-a and network entity 105-a. As discussed herein, in some cases an RBS or commercial network entity other than the network entity 105-a may transmit one or more SIBs, which may create a security vulnerability at the UE 115-a in the event that the UE 115-a were to attempt a network connection such an RBS or undesirable commercial network entity.

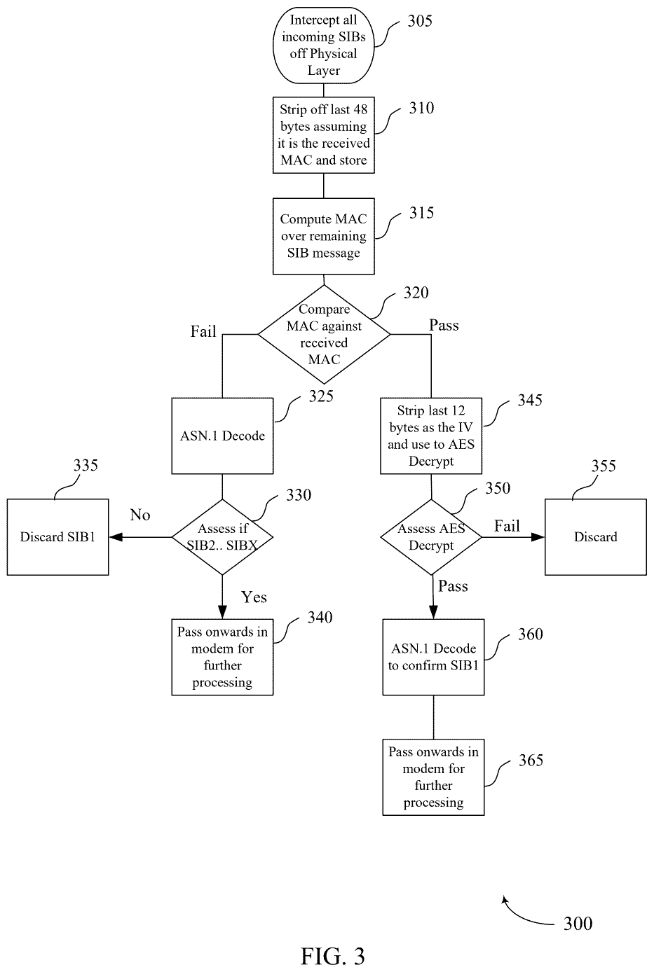

In accordance with techniques as discussed herein, the network entity 105-a may transmit a SIB 210, such as a SIB1 transmission, that includes a MAC that is appended to SIB bits. For example, network entity 105-a, may compute a MAC for an encrypted SIB1, and append the MAC to the SIB1 transmission. In some examples, the SIB1 transmission may include an encrypted SIB payload, and an unencrypted IV used for decryption of the encrypted payload. The network entity 105-a may compute the MAC over the encrypted SIB payload and unencrypted IV, and append the MAC to the SIB1 transmission. The UE 115-a, may receive the SIB1 transmission, strip the received MAC, such as based on a predefined quantity of bits and a predefined location of the bits in the SIB1 transmission, and compute a received MAC based on the remaining bits (that is, the SIB payload and IV). The UE 115-a may compare the computed MAC with the received MAC, and determine whether the SIB1 is authentic based on whether the MACs match. If the MACs match, the SIB1 transmission may be provided for further processing and the UE 115-a may transmit the request message 215, and otherwise the SIB1 transmission may be discarded and the UE 115-a would not perform further processing or transmit a request. FIGS. 3 through 5 show examples of MAC-based authentication for SIBs in accordance with various techniques as discussed herein.

FIG. 3 shows an example of a state diagram 300 that supports SIB encryption in wireless communications in accordance with one or more aspects of the present disclosure. The state diagram 300 may implement or be implemented by aspects of the wireless communications system 100, the wireless communications system 200, or any combination thereof as described with reference to FIGS. 1 and 2. For example, the state diagram 300 may apply to a receiving device such as a UE as described with reference to FIGS. 1 and 2.

Alternative examples of the following may be implemented, where some operations or states are in a different order than described or are not present at all. In some cases, operations may include additional features not mentioned below, or further operations may be added. Although a UE is described as performing various operations, such operations may also be performed by one or more other wireless devices that may receive SIBs from a transmitting device.

In accordance with various aspects, a SIB1 Encryption LPS (low probability of spoofing) techniques may help to prevent rogue base stations (RBS) and commercial networks from attracting a UE away from its Private Network (PN) for exploitation. This act may be referred to as cellular spoofing in some contexts. In some aspects, techniques may use a combination of a cryptographic MAC and encryption between the PN system (e.g., comprising of a 5G core+5G gNB base station) and UE to determine what the UE modem is allowed to process coming in over-the-air at the 5G physical layer, or what to discard. The PN system, in some aspects, may be customized and designed to work in concert with the UE for described LPS techniques.

As discussed herein, in some commercial systems, the SIB1 (System Information Block, type 1) message may be periodically transmitted in the clear (that is, unencrypted) on the downlink from a network entity (e.g., gNB) to UEs, and may be a target for exploitation. At a high level, SIB1 provides SI (system information), scheduling information for other SIBs, and provides basic cell access information that the UE needs to acquire the cell. MAC-based authentication as discussed herein may provide two-fold protection in terms of cellular spoofing mitigation. First, when encrypted, rogue UEs (RUEs) cannot see the SIB1 details and therefore cannot be used in a passive survey mode to provide the PN system's acquisition information to an RBS (rogue base station) to attempt a man-in-the-middle attack. Second, the UE modem may intercept incoming SIB1 messages (regardless if it is from the legitimate PN system, commercial network or RBS) coming off the physical layer before any other modem processing can occur, and compute a MAC (message authentication code) to compare against the received cryptographic MAC. If the MAC is missing or fails the MAC comparison, the modem will discard the SIB1 message and call cell barring processing. Because of this, the modem not provide further processing of SIB1 from a RBS or unauthorized commercial network, thus not able to attach.

With reference to FIG. 3, at 305, the modem may intercept incoming SIBs off the physical layer. At 310, the modem may strip off the last 48 bytes of a SIB transmission. Assuming the SIB has a 48 byte MAC appended thereto, the stripped off bytes correspond to a transmitted MAC that is appended to a transmitted SIB. At 315, the modem may compute its own MAC over the remaining portion of the SIB message (such as the SIB1 payload and IV). At 320, the modem may check the computed MAC against the received MAC. If the MAC check passes, the modem may then decrypt SIB1 by stripping the IV (e.g., the last 12 bytes of the remaining SIB bits) and using it for an Advanced Encryption Standard (AES) decryption procedure, as indicated at 345. The AES decryption procedure at 345 may utilize a pre-shared AES private key stored at the UE, which may correspond to a same AES private key used by an authorized network entity for encryption. Such symmetric AES private keys may enable authorized UEs with the AES private keys to successfully decrypt the SIB1 payload while preventing unauthorized UEs that lack the AES private keys from decrypting the SIB1 payload. The AES decryption procedure may include application of an AES in counter mode (AES-CTR) algorithm using the stripped IV and the stored AES private key to decrypt the SIB payload bits. At 350, the modem may assess the AES decryption. The AES decryption assessment at 350 may establish whether the AES decryption procedure completed successfully by validating a decrypted output format and structure. If the AES private key is incorrect, corrupted, or if the encrypted payload was tampered with during transmission, the AES decryption may fail, producing invalid or corrupted output data. If the AES decryption fails, the modem may discard the SIB as indicated at 355. The discard operation at 355 may occur when AES decryption fails due to an incorrect AES private key, corrupted encrypted payload, or tampered transmission. Such a failure may indicate that the SIB1 transmission did not originate from an authorized network entity with the correct AES encryption key, even if the MAC verification initially passed. Such a failure may provide an additional security layer by ensuring that even if a rogue base station attempts to mimic the MAC structure, the rogue base station cannot produce properly encrypted content without access to the correct AES private key.

If the AES decryption procedure is determined to be successful at 350, the modem may perform an Abstract Syntax Notation One (ASN.1) decoding procedure at 360 to verify that the SIB is SIB1. If the SIB is SIB1, at 365, the modem may pass the SIB1 for further processing.

In the event that the comparison at 320 fails, it may be due to the received SIB being a SIB other than SIB1. SIB1 includes scheduling information for such other SIBs, and thus receipt of such SIBs other than SIB1 may occur if the UE has the appropriate scheduling information from the SIB1. This may be identified, in some implementations, by performing an ASN.1 decode at 325, and assessing at 330 if the decoded data is a SIB other than SIB1. If the decoded data is not a SIB other than a SIB1, it may be discarded at 335 (e.g., a SIB1 without a verified MAC is discarded). If it is determined that the decoded data is a SIB other than SIB1, it may be passed for further processing at 340.

In accordance with such techniques, the modem may avoid acquiring a SIB for any cells except a PN cell, as MAC validation and successful AES decryption is required and used as a whitelist before allowing SIB1 to be processed. The modem code that intercepts these messages directly off the physical layer as they arrive is instrumented as an initial entry point to the modem for processing, hence can be thought of as a secure gateway entry point to the rest of the modem itself. If the PN system is configured for multiple cells, other SIB messages that may be transmitted, such as SIBs that carry neighbor cell acquisition information. These other SIB messages (e.g., SIB2 . . . SIBX) may not be encrypted nor carry a MAC. As discussed, the SIB1 encryption techniques may account for this, will also work for SIB2 . . . SIBX. For example, the modem may not distinguish what SIB messages are coming down PDSCH (physical downlink shared channel) off the physical layer until ASN.1 decode is complete that allows it to read the SIB Type Block indicator. Since SIB2 . . . SIBX will not carry a MAC, the MAC check will fail but the modem will then run through ASN.1 processing to check the SIB type. If the SIB type is SIB2 and upwards, the modem will not discard and allow it to move forward for processing.

As discussed, the SIB payload may be encrypted according to an AES implementation for UE decryption. For example, an AES Counter Mode (CTR) may provide an encryption cipher, and require a 12 byte Initialization Vector (IV). The 12 byte AES IV is appended to SIB1 and sent from the network to the UE to utilize for AES decryption.

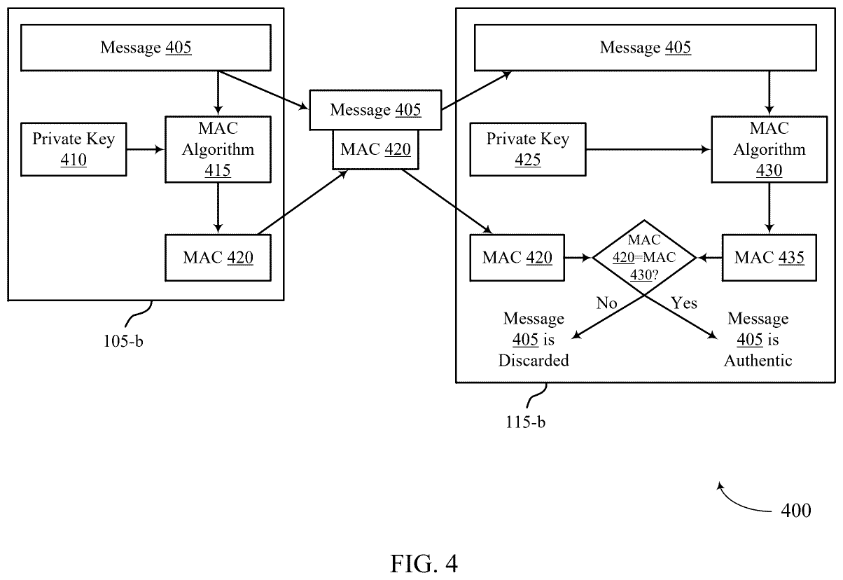

The MAC may be used to verify that the encrypted SIB1 plus the 12 byte IV has not been tampered with in-transit. In some implementations, a hash-based message authentication code (HMAC)-Secure Hash Algorithm (SHA) procedure, such as HMAC-SHA-384, may be used to generate a 48 byte MAC as the output. Both the network entity and UE may use a same HMAC-SHA-384 private key with the HMAC-SHA-384 procedure to assess whether a MAC computed at the UE matches the MAC transmitted with a SIB1 transmission. FIG. 4 shows a general high level MAC functionality for illustrative purposes.

FIG. 4 shows an example of a transmitter and receiver system 400 that supports SIB encryption in wireless communications in accordance with one or more aspects of the present disclosure. The transmitter and receiver system 400 may implement or be implemented by various aspects of the wireless communications system 100, the wireless communications system 200, or the state diagram 300. For example, the transmitter and receiver system 400 may include a network entity 105-b, and a UE 115-b, which may represent examples of corresponding devices as described with reference to FIGS. 1 through 3.

In this example, a message 405, such as a SIB1 message that includes an encrypted SIB payload and an IV, may be transmitted by the network entity 105-b and received at the UE 115-b. The network entity 105-b may perform a MAC algorithm 415 on the message 405 (e.g., an HMAC-SHA-384 procedure) using an HMAC-SHA-384 private key 410, to generate MAC 420 that is appended to the message 405. The UE 115-b, as discussed herein, may strip the MAC from the received transmission and perform MAC algorithm 430 on the remaining portion of the received message using an HMAC-SHA-384 private key 425 to compute a computed MAC 435 that may be compared to received MAC 420 to verify the SIB message is authentic.

In some aspects, a PN gNB may be the network entity 105-b, and an authorized UE 115-b may be the receiver. Prior to the MAC algorithm, the message 405 may be defined as an AES encrypted ASN.1 encoded SIB1 plus 12 byte unencrypted AES IV. In some aspects, the HMAC-SHA-384 private key 410 at the network entity 105-b, and the HMAC-SHA-384 private key 425 at the UE 115-b may be 48 bytes in length in accordance with the HMAC-SHA-384 algorithm, although different length HMAC-SHA-384 private keys may be selected (e.g., a 128 byte private key). The HMAC-SHA-384 private key is the same key used on the PN and on the UE (symmetric cryptography using shared private keys), and may be preprogrammed at the devices, or otherwise provided by the network in accordance with a secure communication procedure.

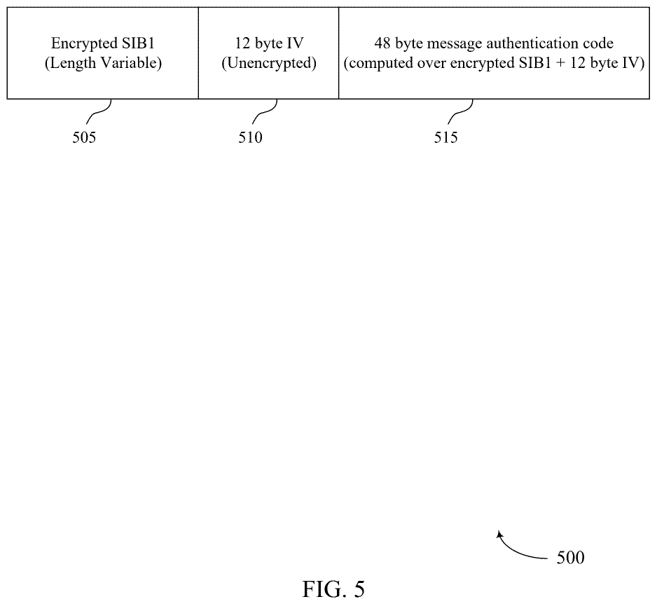

FIG. 5 shows an example of a SIB message 500 that supports SIB encryption in wireless communications in accordance with one or more aspects of the present disclosure. The SIB message 500 may implement or be implemented by various aspects of the wireless communications system 100, the wireless communications system 200, the state diagram 300, or the transmitter and receiver system 400.

In this example, an AES encrypted SIB1 505 is appended by the 12 byte unencrypted IV 510, followed by the 48 byte MAC 515. The order of the IV plus MAC (60 bytes) stored and transmitted may be most significant bit (MSB) big endian, as shown in the example of FIG. 5, or least significant bit (LSB) little endian. The SIB1 505 length varies as each infrastructure vendor may support different optional information elements.

As discussed herein, the appended 60 bytes for the AES IV+MAC may be used as a whitelist for the modem to authenticate valid SIB1 messages coming from the PN system (where it uses a common preshared set of private MAC and AES keys with the UE). All other SIB1 messages incoming to the UE from rogue base stations or commercial networks will not have the MAC nor AES IV appended for the UE to authenticate and decrypt, therefore the receiving modem will discard in accordance with techniques discussed herein. Thus, the modem is prevented from being pulled onto different commercial networks or rogue base stations as it will not see the associated SIB1 messages that contain the related cell acquisition parameters that allows the UE to connect to the cell.

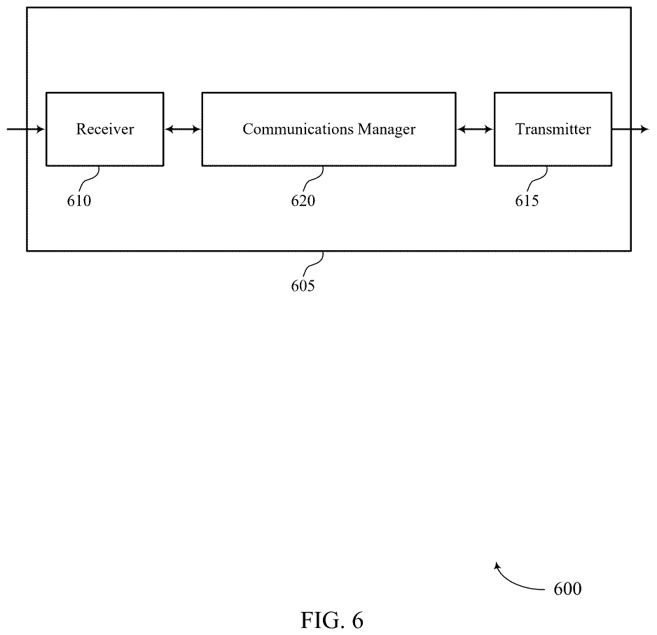

FIG. 6 shows a block diagram 600 of a device 605 that supports SIB encryption in wireless communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to SIB encryption in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SIB encryption in wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of SIB encryption in wireless communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a first SIB at a physical layer of the UE, the first SIB including a set of bits. The communications manager 620 is capable of, configured to, or operable to support a means for partitioning the set of bits of the first SIB into a first subset of bits that correspond to a first message authentication code of the first SIB and a second subset of bits that correspond to SIB bits of the first SIB. The communications manager 620 is capable of, configured to, or operable to support a means for computing a second message authentication code for the second subset of bits in accordance with a hash algorithm associated with the first SIB. The communications manager 620 is capable of, configured to, or operable to support a means for determining whether to process the first SIB or discard the first SIB based on whether the second message authentication code matches the first message authentication code.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for SIB encryption and authentication, which may mitigate security vulnerabilities as discussed herein.

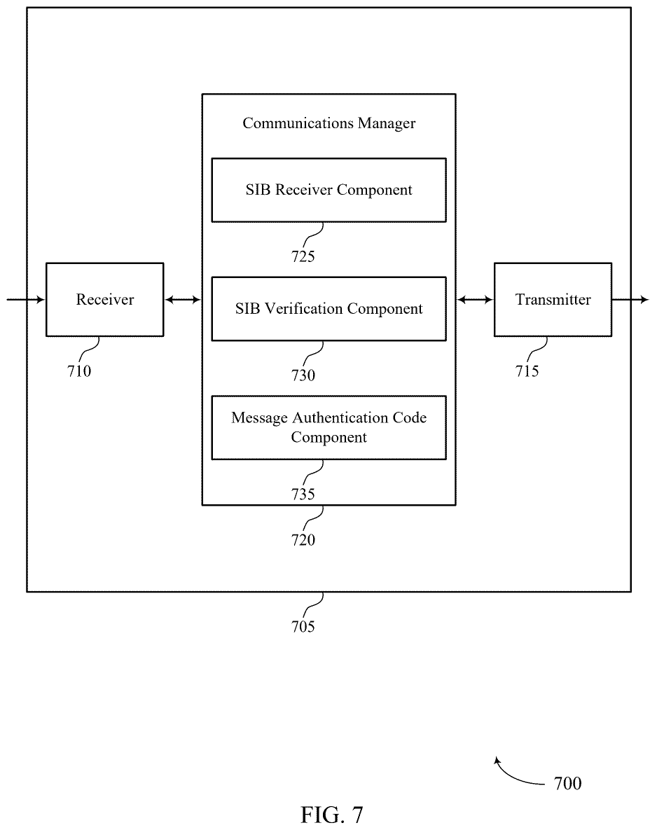

FIG. 7 shows a block diagram 700 of a device 705 that supports SIB encryption in wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to SIB encryption in wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to SIB encryption in wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of SIB encryption in wireless communications as described herein. For example, the communications manager 720 may include an SIB receiver component 725, an SIB verification component 730, a message authentication code component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The SIB receiver component 725 is capable of, configured to, or operable to support a means for receiving a first SIB at a physical layer of the UE, the first SIB including a set of bits. The SIB verification component 730 is capable of, configured to, or operable to support a means for partitioning the set of bits of the first SIB into a first subset of bits that correspond to a first message authentication code of the first SIB and a second subset of bits that correspond to SIB bits of the first SIB. The message authentication code component 735 is capable of, configured to, or operable to support a means for computing a second message authentication code for the second subset of bits in accordance with a hash algorithm associated with the first SIB. The SIB verification component 730 is capable of, configured to, or operable to support a means for determining whether to process the first SIB or discard the first SIB based on whether the second message authentication code matches the first message authentication code.

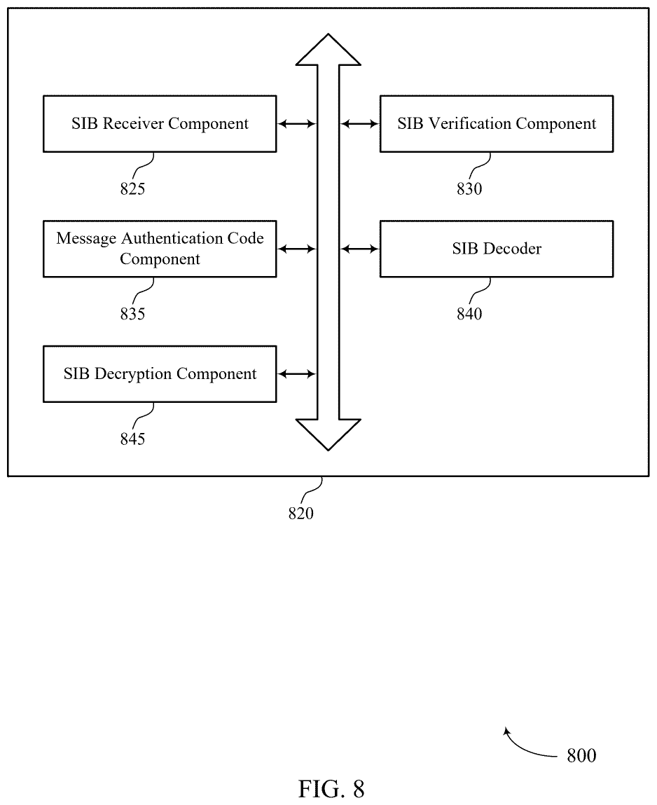

FIG. 8 shows a block diagram 800 of a communications manager 820 that supports SIB encryption in wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of SIB encryption in wireless communications as described herein. For example, the communications manager 820 may include an SIB receiver component 825, an SIB verification component 830, a message authentication code component 835, an SIB decoder 840, an SIB decryption component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The SIB receiver component 825 is capable of, configured to, or operable to support a means for receiving a first SIB at a physical layer of the UE, the first SIB including a set of bits. The SIB verification component 830 is capable of, configured to, or operable to support a means for partitioning the set of bits of the first SIB into a first subset of bits that correspond to a first message authentication code of the first SIB and a second subset of bits that correspond to SIB bits of the first SIB. The message authentication code component 835 is capable of, configured to, or operable to support a means for computing a second message authentication code for the second subset of bits in accordance with a hash algorithm associated with the first SIB. In some examples, the SIB verification component 830 is capable of, configured to, or operable to support a means for determining whether to process the first SIB or discard the first SIB based on whether the second message authentication code matches the first message authentication code.

In some examples, the SIB decoder 840 is capable of, configured to, or operable to support a means for decoding, based on the second message authentication code being different than the first message authentication code, at least a portion of the first SIB to obtain a decoded portion of the first SIB that indicates whether the first SIB is a SIB1 or a different SIB. In some examples, the SIB verification component 830 is capable of, configured to, or operable to support a means for discarding the first SIB when the first SIB is the SIB1, or providing the first SIB for further processing when the first SIB is the different SIB.

In some examples, to support decoding, the SIB decoder 840 is capable of, configured to, or operable to support a means for decoding at least the portion of the first SIB in accordance with an Abstract Syntax Notation One (ASN.1) decoding procedure.

In some examples, the SIB verification component 830 is capable of, configured to, or operable to support a means for partitioning, based on the second message authentication code matching the first message authentication code, the SIB bits of the first SIB into SIB payload bits and an initialization vector. As used herein, SIB payload bits or SIB bits may refer to bits that carry information or data content of a SIB. SIB payload bits or SIB bits may carry system parameters and configuration data that enable a UE to acquire and connect to a cell. SIB payload bits or SIB bits may contain cell access parameters, RRC parameters, system timing information, access control parameters, scheduling information, mobility parameters, and service information, among other examples. In some aspects, SIB payload bits or SIB bits may be distinct from appended security elements of the SIB (such as an initialization vector and a MAC). As used herein, an initialization vector may refer to a cryptographic parameter used in encryption algorithms to ensure that identical plaintext messages produce different ciphertext outputs, even when encrypted with the same key. An initialization vector may act as a randomizing factor that prevents pattern recognition in encrypted data and enhances security by making each encryption operation unique. In some examples, the SIB decryption component 845 is capable of, configured to, or operable to support a means for decrypting the SIB payload bits in accordance with an Advanced Encryption Standard (AES) procedure using the initialization vector.

In some examples, the SIB verification component 830 is capable of, configured to, or operable to support a means for discarding the first SIB when the AES procedure indicates a failed decryption. In some examples, the SIB decoder 840 is capable of, configured to, or operable to support a means for decoding at least a portion of the SIB payload in accordance with an Abstract Syntax Notation One (ASN.1) decoding procedure to confirm the first SIB is a SIB1 and providing the first SIB for further processing.

In some examples, the initialization vector is a 12 byte AES initialization vector that is appended to the SIB payload bits.

In some examples, the first message authentication code is a 48 byte code appended to the SIB bits of the first SIB, where the SIB bits include a SIB payload and an initialization vector, and where the second message authentication code is a corresponding 48 byte code computed on the SIB payload and the initialization vector using a hash-based message authentication code (HMAC)-Secure Hash Algorithm (SHA)-384 procedure and an HMAC-SHA-384 private key at the UE. In some examples, the HMAC-SHA-384 private key at the UE is a 48 byte private key that is stored at the UE.

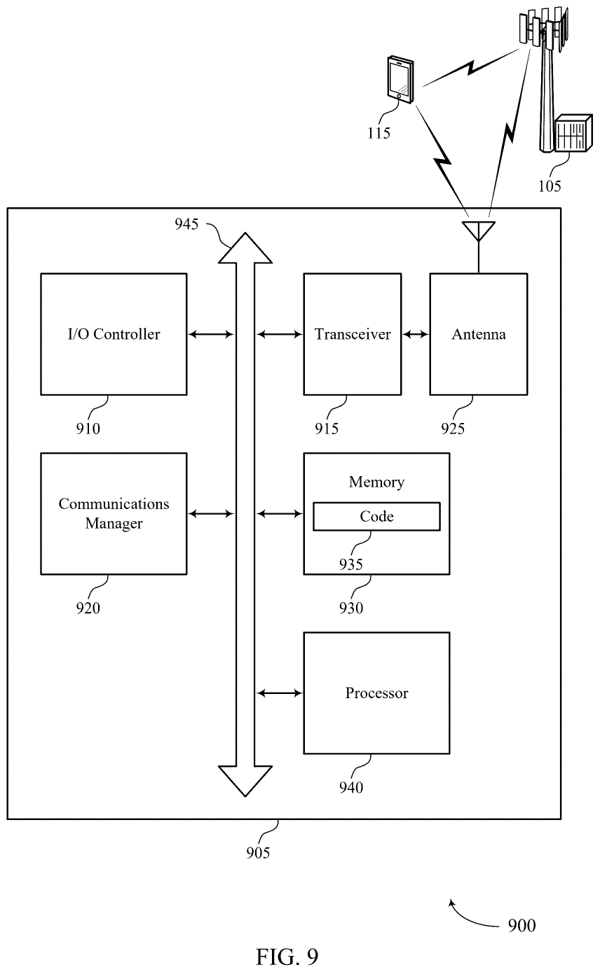

FIG. 9 shows a diagram of a system 900 including a device 905 that supports SIB encryption in wireless communications in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting SIB encryption in wireless communications). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a first SIB at a physical layer of the UE, the first SIB including a set of bits. The communications manager 920 is capable of, configured to, or operable to support a means for partitioning the set of bits of the first SIB into a first subset of bits that correspond to a first message authentication code of the first SIB and a second subset of bits that correspond to SIB bits of the first SIB. The communications manager 920 is capable of, configured to, or operable to support a means for computing a second message authentication code for the second subset of bits in accordance with a hash algorithm associated with the first SIB. The communications manager 920 is capable of, configured to, or operable to support a means for determining whether to process the first SIB or discard the first SIB based on whether the second message authentication code matches the first message authentication code.

By including or configuring the communications manager 920 in accordance with examples as described herein, the device 905 may support techniques for SIB encryption and authentication, which may mitigate security vulnerabilities as discussed herein.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of SIB encryption in wireless communications as described herein, or the at least one processor 940 and the at least one memory 930 may be otherwise configured to, individually or collectively, perform or support such operations.

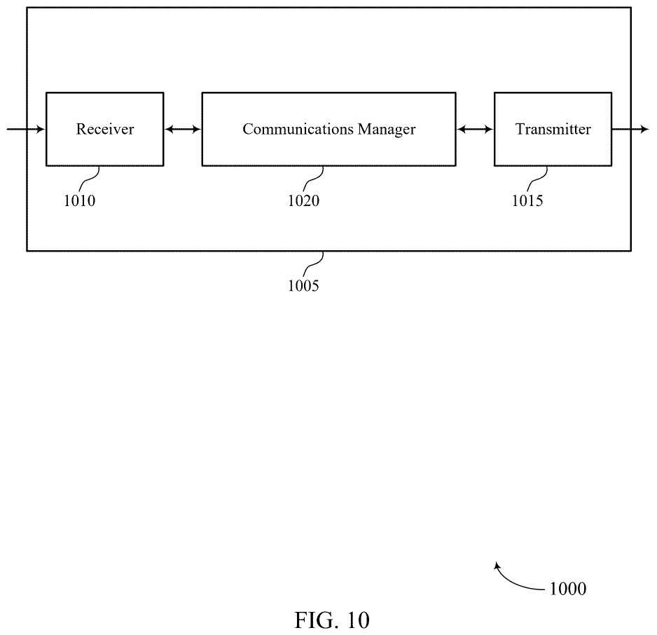

FIG. 10 shows a block diagram 1000 of a device 1005 that supports SIB encryption in wireless communications in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of SIB encryption in wireless communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for encrypting an SIB payload in accordance with an encryption algorithm and generating an associated initialization vector for decryption of the SIB payload. The communications manager 1020 is capable of, configured to, or operable to support a means for computing a first message authentication code in accordance with a hash algorithm performed on the SIB payload and the associated initialization vector. The communications manager 1020 is capable of, configured to, or operable to support a means for transmitting a first SIB message that includes the SIB payload, the associated initialization vector, and the first message authentication code.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for SIB encryption and authentication, which may mitigate security vulnerabilities as discussed herein.

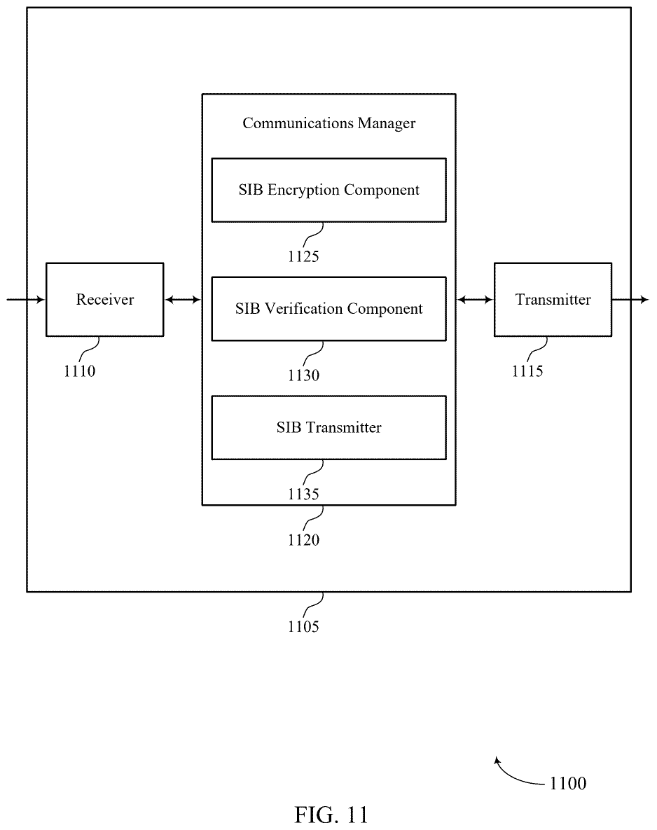

FIG. 11 shows a block diagram 1100 of a device 1105 that supports SIB encryption in wireless communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of SIB encryption in wireless communications as described herein. For example, the communications manager 1120 may include an SIB encryption component 1125, an SIB verification component 1130, an SIB transmitter 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The SIB encryption component 1125 is capable of, configured to, or operable to support a means for encrypting an SIB payload in accordance with an encryption algorithm and generating an associated initialization vector for decryption of the SIB payload. The SIB verification component 1130 is capable of, configured to, or operable to support a means for computing a first message authentication code in accordance with a hash algorithm performed on the SIB payload and the associated initialization vector. The SIB transmitter 1135 is capable of, configured to, or operable to support a means for transmitting a first SIB message that includes the SIB payload, the associated initialization vector, and the first message authentication code.

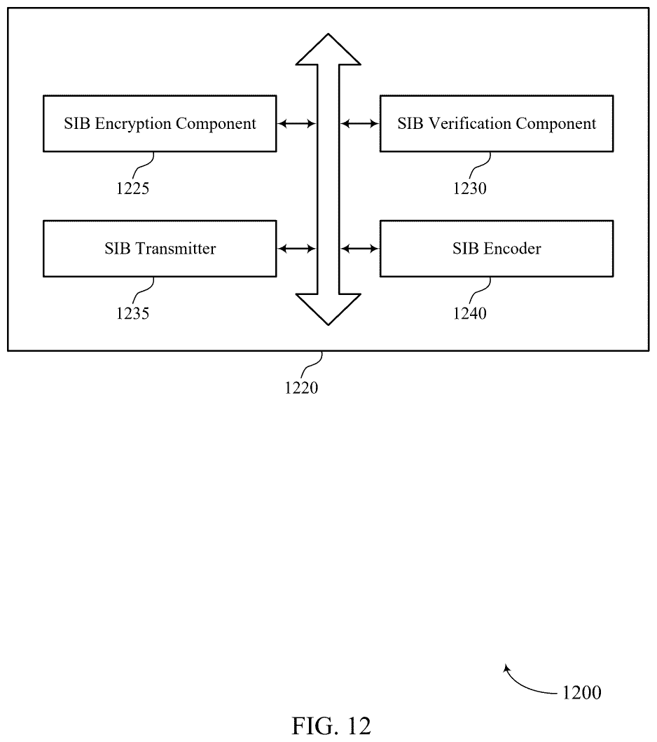

FIG. 12 shows a block diagram 1200 of a communications manager 1220 that supports SIB encryption in wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of SIB encryption in wireless communications as described herein. For example, the communications manager 1220 may include an SIB encryption component 1225, an SIB verification component 1230, an SIB transmitter 1235, an SIB encoder 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The SIB encryption component 1225 is capable of, configured to, or operable to support a means for encrypting an SIB payload in accordance with an encryption algorithm and generating an associated initialization vector for decryption of the SIB payload. The SIB verification component 1230 is capable of, configured to, or operable to support a means for computing a first message authentication code in accordance with a hash algorithm performed on the SIB payload and the associated initialization vector. The SIB transmitter 1235 is capable of, configured to, or operable to support a means for transmitting a first SIB message that includes the SIB payload, the associated initialization vector, and the first message authentication code.

In some examples, the SIB payload is a SIB1 payload.

In some examples, the SIB encoder 1240 is capable of, configured to, or operable to support a means for encoding the SIB payload in accordance with an ASN.1 encoding procedure. In some examples, the encryption algorithm is an AES algorithm that encrypts the SIB payload by using the initialization vector. In some examples, the initialization vector is a 12 byte AES initialization vector that is appended to the SIB payload.

In some examples, the first message authentication code is a 48 byte code appended to the SIB payload and the initialization vector, and where the 48 byte code is computed on the SIB payload and the initialization vector using an HMAC-SHA-384 hashing algorithm and an HMAC-SHA-384 private key at the network entity. In some examples, the HMAC-SHA-384 private key at the network entity is a 48 byte private key that corresponds to an associated HMAC-SHA-384 private key of at least a first UE that is authorized for communication with the network entity.

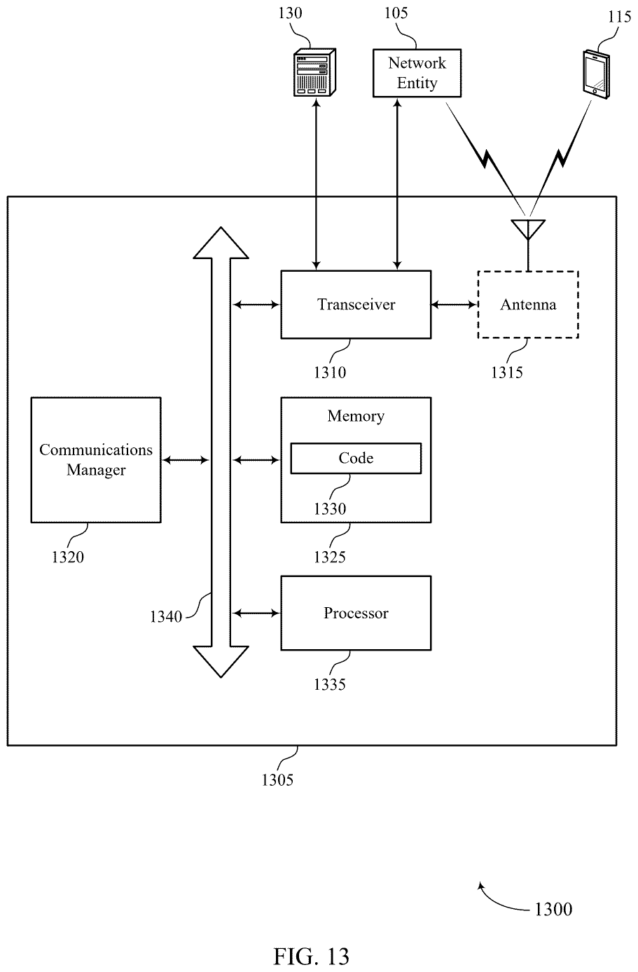

FIG. 13 shows a diagram of a system 1300 including a device 1305 that supports SIB encryption in wireless communications in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting SIB encryption in wireless communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for encrypting an SIB payload in accordance with an encryption algorithm and generating an associated initialization vector for decryption of the SIB payload. The communications manager 1320 is capable of, configured to, or operable to support a means for computing a first message authentication code in accordance with a hash algorithm performed on the SIB payload and the associated initialization vector. The communications manager 1320 is capable of, configured to, or operable to support a means for transmitting a first SIB message that includes the SIB payload, the associated initialization vector, and the first message authentication code.

By including or configuring the communications manager 1320 in accordance with examples as described herein, the device 1305 may support techniques for SIB encryption and authentication, which may mitigate security vulnerabilities as discussed herein.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of SIB encryption in wireless communications as described herein, or the at least one processor 1335 and the at least one memory 1325 may be otherwise configured to, individually or collectively, perform or support such operations.

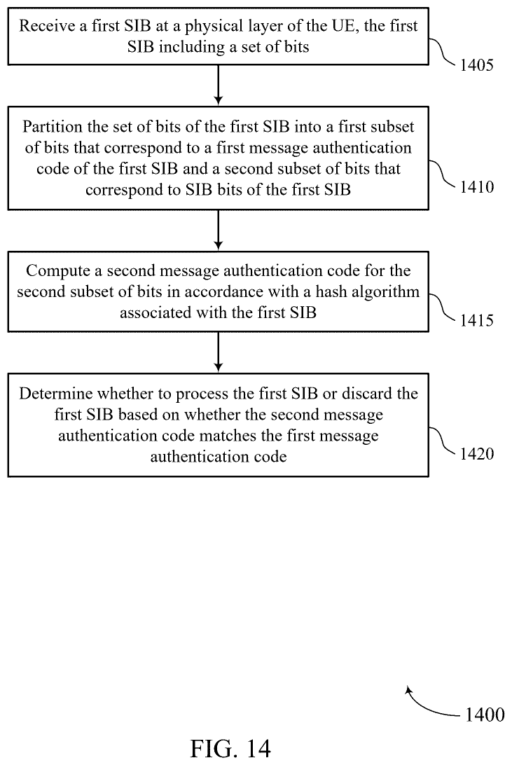

FIG. 14 shows a flowchart illustrating a method 1400 that supports SIB encryption in wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a first SIB at a physical layer of the UE, the first SIB including a set of bits. The operations of 1405 may be performed in accordance with examples as disclosed herein. In some examples, aspects of the operations of 1405 may be performed by an SIB receiver component 825 as described with reference to FIG. 8.

At 1410, the method may include partitioning the set of bits of the first SIB into a first subset of bits that correspond to a first message authentication code of the first SIB and a second subset of bits that correspond to SIB bits of the first SIB. The operations of 1410 may be performed in accordance with examples as disclosed herein. In some examples, aspects of the operations of 1410 may be performed by an SIB verification component 830 as described with reference to FIG. 8.

At 1415, the method may include computing a second message authentication code for the second subset of bits in accordance with a hash algorithm associated with the first SIB. The operations of 1415 may be performed in accordance with examples as disclosed herein. In some examples, aspects of the operations of 1415 may be performed by a message authentication code component 835 as described with reference to FIG. 8.

At 1420, the method may include determining whether to process the first SIB or discard the first SIB based on whether the second message authentication code matches the first message authentication code. The operations of 1420 may be performed in accordance with examples as disclosed herein. In some examples, aspects of the operations of 1420 may be performed by an SIB verification component 830 as described with reference to FIG. 8.

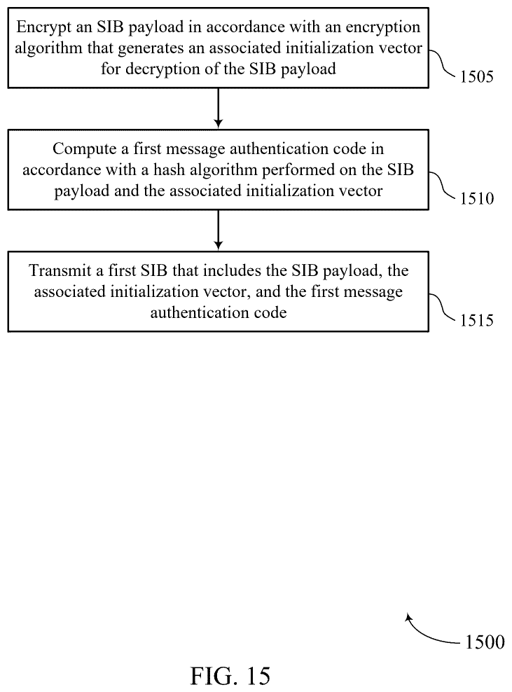

FIG. 15 shows a flowchart illustrating a method 1500 that supports SIB encryption in wireless communications in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include encrypting an SIB payload in accordance with an encryption algorithm and generating an associated initialization vector for decryption of the SIB payload. The operations of 1505 may be performed in accordance with examples as disclosed herein. In some examples, aspects of the operations of 1505 may be performed by an SIB encryption component 1225 as described with reference to FIG. 12.

At 1510, the method may include computing a first message authentication code in accordance with a hash algorithm performed on the SIB payload and the associated initialization vector. The operations of 1510 may be performed in accordance with examples as disclosed herein. In some examples, aspects of the operations of 1510 may be performed by an SIB verification component 1230 as described with reference to FIG. 12.

At 1515, the method may include transmitting a first SIB message that includes the SIB payload, the associated initialization vector, and the first message authentication code. The operations of 1515 may be performed in accordance with examples as disclosed herein. In some examples, aspects of the operations of 1515 may be performed by an SIB transmitter 1235 as described with reference to FIG. 12.

The following provides an overview of aspects of the present disclosure:
Aspect 1: A method for wireless communications at a UE, comprising: receiving a first SIB at a physical layer of the UE, the first SIB comprising a set of bits; partitioning the set of bits of the first SIB into a first subset of bits that correspond to a first message authentication code of the first SIB and a second subset of bits that correspond to SIB bits of the first SIB; computing a second message authentication code for the second subset of bits in accordance with a hash algorithm associated with the first SIB; and determining whether to process the first SIB or discard the first SIB based at least in part on whether the second message authentication code matches the first message authentication code.
Aspect 2: The method of aspect 1, further comprising: decoding, based at least in part on the second message authentication code being different than the first message authentication code, at least a portion of the first SIB to obtain a decoded portion of the first SIB that indicates whether the first SIB is a SIB1 or a different SIB; and discarding the first SIB when the first SIB is the SIB1, or providing the first SIB for further processing when the first SIB is the different SIB.
Aspect 3: The method of aspect 2, wherein the decoding comprises: decoding at least the portion of the first SIB in accordance with an Abstract Syntax Notation One (ASN.1) decoding procedure.
Aspect 4: The method of any of aspects 1 through 3, further comprising: partitioning, based at least in part on the second message authentication code matching the first message authentication code, the SIB bits of the first SIB into SIB payload bits and an initialization vector; and decrypting the SIB payload bits in accordance with an Advanced Encryption Standard (AES) procedure using the initialization vector.
Aspect 5: The method of aspect 4, further comprising: discarding the first SIB when the AES procedure indicates a failed decryption; or decoding at least a portion of the SIB payload in accordance with an Abstract Syntax Notation One (ASN.1) decoding procedure to confirm the first SIB is a SIB1 and providing the first SIB for further processing.
Aspect 6: The method of any of aspects 4 through 5, wherein the initialization vector is a 12 byte AES initialization vector that is appended to the SIB payload bits.
Aspect 7: The method of any of aspects 1 through 6, wherein the first message authentication code is a 48 byte code appended to the SIB bits of the first SIB, wherein the SIB bits include a SIB payload and an initialization vector, and wherein the second message authentication code is a corresponding 48 byte code computed on the SIB payload and the initialization vector using a hash-based message authentication code (HMAC)-Secure Hash Algorithm (SHA)-384 procedure and an HMAC-SHA-384 private key at the UE.
Aspect 8: The method of aspect 7, wherein the HMAC-SHA-384 private key at the UE is a 48 byte private key that is stored at the UE.
Aspect 9: A method for wireless communications at a network entity, comprising: encrypting an SIB payload in accordance with an encryption algorithm and generating an associated initialization vector for decryption of the SIB payload; computing a first message authentication code in accordance with a hash algorithm performed on the SIB payload and the associated initialization vector; and transmitting a first SIB message that comprises the SIB payload, the associated initialization vector, and the first message authentication code.
Aspect 10: The method of aspect 9, wherein the SIB payload is a SIB1 payload.
Aspect 11: The method of any of aspects 9 through 10, further comprising: encoding the SIB payload in accordance with an Abstract Syntax Notation One (ASN.1) encoding procedure.
Aspect 12: The method of any of aspects 9 through 11, wherein the encryption algorithm is an Advanced Encryption Standard (AES) algorithm that encrypts the SIB payload by using the initialization vector.
Aspect 13: The method of aspect 12, wherein the initialization vector is a 12 byte AES initialization vector that is appended to the SIB payload.
Aspect 14: The method of any of aspects 9 through 13, wherein the first message authentication code is a 48 byte code appended to the SIB payload and the initialization vector, and wherein the 48 byte code is computed on the SIB payload and the initialization vector using a hash-based message authentication code (HMAC)-Secure Hash Algorithm (SHA)-384 encryption procedure and an HMAC-SHA-384 private key at the network entity.
Aspect 15: The method of aspect 14, wherein the HMAC-SHA-384 private key at the network entity is a 48 byte private key that corresponds to an associated HMAC-SHA-384 private key of at least a first UE that is authorized for communication with the network entity.
Aspect 16: A UE for wireless communications, comprising one or more memories storing processor-executable code, and one or more processors coupled with the one or more memories and individually or collectively operable to execute the code to cause the UE to perform a method of any of aspects 1 through 8.
Aspect 17: A UE for wireless communications, comprising at least one means for performing a method of any of aspects 1 through 8.
Aspect 18: A non-transitory computer-readable medium storing code for wireless communications, the code comprising instructions executable by one or more processors to perform a method of any of aspects 1 through 8.
Aspect 19: A network entity for wireless communications, comprising one or more memories storing processor-executable code, and one or more processors coupled with the one or more memories and individually or collectively operable to execute the code to cause the network entity to perform a method of any of aspects 9 through 15.
Aspect 20: A network entity for wireless communications, comprising at least one means for performing a method of any of aspects 9 through 15.
Aspect 21: A non-transitory computer-readable medium storing code for wireless communications, the code comprising instructions executable by one or more processors to perform a method of any of aspects 9 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a first system information block (SIB) at a physical layer of the UE, the first SIB comprising a set of bits;
partitioning the set of bits of the first SIB into a first subset of bits that correspond to a first message authentication code of the first SIB and a second subset of bits that correspond to SIB bits of the first SIB;
computing a second message authentication code for the second subset of bits in accordance with a hash algorithm associated with the first SIB; and
determining whether to process the first SIB or discard the first SIB based at least in part on whether the second message authentication code matches the first message authentication code.

2. The method of claim 1, further comprising:
decoding, based on the second message authentication code being different than the first message authentication code, at least a portion of the first SIB to obtain a decoded portion of the first SIB that indicates whether the first SIB is a SIB1 or a different SIB; and
discarding the first SIB when the first SIB is the SIB1, or providing the first SIB for further processing when the first SIB is the different SIB.

3. The method of claim 2, wherein the decoding comprises:
decoding at least the portion of the first SIB in accordance with an Abstract Syntax Notation One (ASN.1) decoding procedure. The method of claim 1, further comprising:
partitioning, based at least in part on the second message authentication code matching the first message authentication code, the SIB bits of the first SIB into SIB payload bits and an initialization vector; and
decrypting the SIB payload bits in accordance with an Advanced Encryption Standard (AES) procedure using the initialization vector.

5. The method of claim 4, further comprising:
discarding the first SIB when the AES procedure indicates a failed decryption; or
decoding at least a portion of the SIB payload in accordance with an Abstract Syntax Notation One (ASN.1) decoding procedure to confirm the first SIB is a SIB1 and providing the first SIB for further processing.

6. The method of claim 4, wherein:
the initialization vector is a 12 byte AES initialization vector that is appended to the SIB payload bits.

7. The method of claim 1, wherein:
the first message authentication code is a 48 byte code appended to the SIB bits of the first SIB, wherein the SIB bits include a SIB payload and an initialization vector, and wherein the second message authentication code is a corresponding 48 byte code computed on the SIB payload and the initialization vector using a hash-based message authentication code (HMAC)-Secure Hash Algorithm (SHA)-384 procedure and an HMAC-SHA-384 private key at the UE.

8. The method of claim 7, wherein:
the HMAC-SHA-384 private key at the UE is a 48 byte private key that is stored at the UE.

9. A user equipment (UE), comprising:
one or more memories storing processor-executable code; and
one or more processors coupled with the one or more memories and individually or collectively operable to execute the code to cause the UE to:
receive a first system information block (SIB) at a physical layer of the UE, the first SIB comprising a set of bits;
partition the set of bits of the first SIB into a first subset of bits that correspond to a first message authentication code of the first SIB and a second subset of bits that correspond to SIB bits of the first SIB;
compute a second message authentication code for the second subset of bits in accordance with a hash algorithm associated with the first SIB; and
determine whether to process the first SIB or discard the first SIB based at least in part on whether the second message authentication code matches the first message authentication code.

10. The UE of claim 9, wherein the one or more processors are individually or collectively further operable to execute the code to cause the UE to:
decode, based at least in part on the second message authentication code being different than the first message authentication code, at least a portion of the first SIB to obtain a decoded portion of the first SIB that indicates whether the first SIB is a SIB1 or a different SIB; and
discard the first SIB when the first SIB is the SIB1, or providing the first SIB for further processing when the first SIB is the different SIB.

11. The UE of claim 10, wherein, to decoding, the one or more processors are individually or collectively operable to execute the code to cause the UE to:
decode at least the portion of the first SIB in accordance with an Abstract Syntax Notation One (ASN.1) decoding procedure.

12. The UE of claim 9, wherein the one or more processors are individually or collectively further operable to execute the code to cause the UE to:
partition, based at least in part on the second message authentication code matching the first message authentication code, the SIB bits of the first SIB into SIB payload bits and an initialization vector; and
decrypt the SIB payload bits in accordance with an Advanced Encryption Standard (AES) procedure using the initialization vector.

13. The UE of claim 12, wherein the one or more processors are individually or collectively further operable to execute the code to cause the UE to:
discard the first SIB when the AES procedure indicates a failed decryption; or
decode at least a portion of the SIB payload in accordance with an Abstract Syntax Notation One (ASN.1) decoding procedure to confirm the first SIB is a SIB1 and providing the first SIB for further processing.

14. The UE of claim 12, wherein the initialization vector is a 12 byte AES initialization vector that is appended to the SIB payload bits.

15. The UE of claim 9, wherein the first message authentication code is a 48 byte code appended to the SIB bits of the first SIB, wherein the SIB bits include a SIB payload and an initialization vector, and wherein the second message authentication code is a corresponding 48 byte code computed on the SIB payload and the initialization vector using a hash-based message authentication code (HMAC)-Secure Hash Algorithm (SHA)-384 procedure and an HMAC-SHA-384 private key at the UE.

16. The UE of claim 15, wherein the HMAC-SHA-384 private key at the UE is a 48 byte private key that is stored at the UE.

17. A non-transitory computer-readable medium storing code for wireless communications, the code comprising instructions executable by one or more processors to:
receive a first system information block (SIB) at a physical layer of a user equipment (UE), the first SIB comprising a set of bits;
partition the set of bits of the first SIB into a first subset of bits that correspond to a first message authentication code of the first SIB and a second subset of bits that correspond to SIB bits of the first SIB;
compute a second message authentication code for the second subset of bits in accordance with a hash algorithm associated with the first SIB; and
determine whether to process the first SIB or discard the first SIB based at least in part on whether the second message authentication code matches the first message authentication code.

18. The non-transitory computer-readable medium of claim 17, wherein the instructions are further executable by the one or more processors to:
decode, based at least in part on the second message authentication code being different than the first message authentication code, at least a portion of the first SIB to obtain a decoded portion of the first SIB that indicates whether the first SIB is a SIB1 or a different SIB; and
discard the first SIB when the first SIB is the SIB1, or providing the first SIB for further processing when the first SIB is the different SIB.

19. The non-transitory computer-readable medium of claim 18, wherein the instructions to decoding are executable by the one or more processors to:
decode at least the portion of the first SIB in accordance with an Abstract Syntax Notation One (ASN.1) decoding procedure.

20. The non-transitory computer-readable medium of claim 17, wherein the instructions are further executable by the one or more processors to:
partition, based at least in part on the second message authentication code matching the first message authentication code, the SIB bits of the first SIB into SIB payload bits and an initialization vector; and
decrypt the SIB payload bits in accordance with an Advanced Encryption Standard (AES) procedure using the initialization vector.
